(19) United States
(12) Patent Application Publication
(10) Pub. No.: US 2014/0001997 A1
(43) Pub. Date: Jan. 2, 2014

(54) MOTOR AND METHOD OF MEASURING AND CONTROLLING DISTANCE OF AIR GAP BETWEEN ROTOR AND STATOR ASSEMBLY

(71) Applicant: SAMSUNG ELECTRO-MECHANICS CO., LTD., Suwon (KR)

(72) Inventor: Gyoung Tai Kim, Suwon (KR)

(73) Assignee: SAMSUNG ELECTRO-MECHANICS CO., LTD., Suwon (KR)

(21) Appl. No.: 13/893,200

(22) Filed: May 13, 2013

(30) Foreign Application Priority Data
Jun. 29, 2012 (KR) 10-2012-0070933

(51) Int. Cl. H02K 11/00; H02P 23/00

(52) U.S. Cl. CPC H02K 11/001; H02P 23/0036
USPC 318/490; 310/68 B

(57) ABSTRACT

Disclosed herein is a motor including: a rotor including a shaft; a stator assembly rotatably supporting the rotor; and an air gap measuring module measuring a distance of an air gap between the shaft and the stator assembly by electromotive force generated between the rotor and the stator assembly. The distance of the air gap between the rotor and the stator assembly is measured through the electromotive force generated between the rotor and the stator assembly and the driving of the motor is controlled by the distance of the air gap.

### CROSS REFERENCE TO RELATED APPLICATION

This application claims the benefit of Korean Patent Application No. 10-2012-0070933, filed on Jun. 29, 2012, entitled “Motor, Measure Method for Distance of Air Gap between Rotor and Stator Assembly, and Control Method using the Same”, which is hereby incorporated by reference in its entirety into this application.

### BACKGROUND OF THE INVENTION

1. Technical Field

The present invention relates to a motor and a method of measuring a distance of an air gap between a rotor and a stator assembly and controlling the driving of the motor.

2. Description of the Related Art

Generally, a motor includes a rotor rotatably mounted in a stator and rotates the rotor by electromagnetic force or a reluctance torque generated between the rotor and the stator.

As an example, a switched reluctance motor rotates a rotor using a reluctance torque according to a change in a magnetic reluctance. The switched reluctance motor as described above has advantages such as a cheap cost, high reliability, and a permanent lifespan.

However, in a motor according to the prior art including a switched reluctance motor as disclosed in Patent Document listed in the following Prior Art Document, an air gap between a stator and a rotor has an effect on vibration, noise, and efficiency of the motor.

Therefore, it is required to precisely control the air gap between the stator and the rotor. However, it is difficult to measure and evaluate the air gap during driving of the motor and it is difficult to control the air gap during driving of the motor according to the evaluation of the air gap.

### RELATED ART DOCUMENT

### [Patent Document]

(Patent Document 1) US 2010-0068558 A1

### SUMMARY OF THE INVENTION

The present invention has been made in an effort to provide a motor and a method of measuring a distance of an air gap between a rotor and a stator assembly and controlling the driving of the motor by electromotive force generated between the rotor and the stator assembly.

Further, the present invention has been made in an effort to provide a motor capable of measuring an air gap between a rotor and a stator assembly during driving of the motor to recognize a mechanical assembling state, an operation state, unbalance of a shaft, and the like, and reflecting the recognized information in controlling the driving of the motor.

Further, the present invention has been made in an effort to provide a method of measuring a distance of an air gap between a rotor and a stator assembly of a motor capable of generating electromotive force between the rotor and the stator assembly, measuring the generated electromotive force, and comparing the measured electromotive force with existing electromotive force data according to an air gap to calculate a distance of the air gap, thereby controlling the driving of the motor.

According to a preferred embodiment of the present invention, there is provided a motor including: a rotor including a shaft; a stator assembly rotatably supporting the rotor; and an air gap measuring module measuring a distance of an air gap between the shaft and the stator assembly by electromotive force generated between the rotor and the stator assembly.

The air gap measuring module may include: an electromotive force generating unit generating electromotive force in the rotor and the stator assembly; an electromotive force measuring unit measuring the electromotive force generated in the electromotive force generating unit; a comparing calculating unit comparing electromotive force data measured in the electromotive force measuring unit with existing electromotive force data according to an air gap to calculate the distance of the air gap; and a controlling unit controlling the driving of the motor through the distance of the air gap calculated in the comparing calculating unit.

The air gap measuring module may further include a display unit displaying an operation state of the motor including the distance of the air gap, a state of the air gap, and a driving speed of the motor by the controlling unit.

The electromotive force generating unit may include: a permanent magnet on the shaft of the rotor; and an induction coil part mounted on the stator assembly so as to face the permanent magnet and including a coil wound therearound.

A plurality of permanent magnets may be mounted on the shaft in a circumferential direction and a space part may be formed between adjacent permanent magnets.

The electromotive force measuring unit may measure analog electromotive force data generated in the electromotive force generating unit, and the comparing calculating unit may convert the measured analog electromotive force data into digital electromotive force data and compare the digital electromotive force data with pre-stored electromotive force data according to an air gap and calculate the distance of the air gap.

The controlling unit may control acceleration, deceleration, and stop of a motor driving speed according to the air gap calculated in the comparing calculating unit.

The rotor may be provided with a salient pole protruding toward the stator assembly and the stator assembly may be provided with a stator salient pole facing the salient pole of the rotor and having a coil wound therearound, such that the motor is implemented as a switched reluctance motor.

A permanent magnet may be mounted to be attachable to/detachable from one end portion of the shaft of the rotor, and an induction coil part may be mounted to be attachable to/detachable from the stator assembly facing the permanent magnet.

According to another preferred embodiment of the present invention, there is provided a motor and a method of measuring a distance of an air gap between a rotor and a stator assembly and controlling the driving of the motor as described above, the method including: an electromotive force generating step of generating electromotive force by an induction winding between the rotor and the stator assembly; an electromotive force measuring step of measuring the generated electromotive force; an air gap distance comparing and calculating step of comparing the measured electromotive force data with existing electromotive force data according to a distance of an air gap to calculate a distance of the air gap; and a controlling step of controlling the driving of the motor according to the distance of the air gap.

In the electromotive force generating step, current may be applied to an induction coil part mounted on the stator assembly so as to face a permanent magnet mounted on the rotor according to the driving of the motor.

In the electromotive force measuring step, the electromotive force generated in the electromotive force generating step may be measured for each time zone.

In the control step, a speed of the motor may be controlled to be acceleration, deceleration, and stop according to the distance of the air gap.

The method may further include a display step of displaying an operation state of the motor including the distance of the air gap, a state of the air gap, and a driving speed of the motor in the controlling step.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a configuration diagram schematically showing a motor according to a preferred embodiment of the present invention;

FIG. 2 is a configuration diagram schematically showing an air gap measuring module of the motor according to the preferred embodiment of the present invention; and

FIG. 3 is a flow chart schematically showing a method of measuring and controlling a distance of an air gap between a rotor and a stator assembly of the motor according to the preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

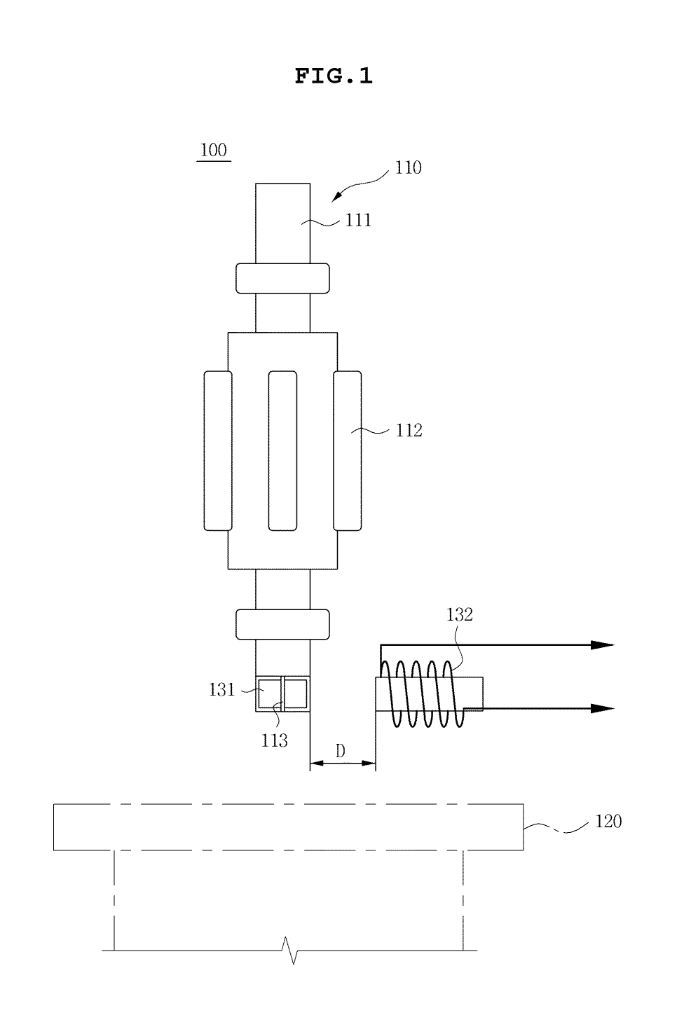

FIG. 1 is a configuration diagram schematically showing a motor according to a preferred embodiment of the present invention. As shown in FIG. 1, the motor 100 is configured to include a rotor 110 including a shaft, a stator assembly 120, and an air gap measuring module 130 measuring an air gap between the shaft and the stator assembly by electromotive force generated between the rotor and the stator assembly 120.

More specifically, the rotor 110 includes the shaft 111, and the stator assembly rotatably supports the rotor. In addition, the stator assembly means one body of a housing part including a stator.

Further, the air measuring module 130 includes a permanent magnet 131 mounted on the shaft 111 and an induction coil part 132 mounted on the stator assembly 120 so as to face the permanent magnet 131 and having a coil wound therearound.

Further, a plurality of permanent magnets 131 are mounted on the shaft 111 in a circumferential direction and a space part 113 is formed between adjacent permanent magnets of the shaft 111.

The space part 113 is to form a section at which a signal is not detected. Readability of electromotive force measuring data may be increased through the space part 113.

Further, the permanent magnet 131 may be mounted to be attachable to/detachable from one end portion of the shaft 111 of the rotor 110, and the induction coil part 132 may be mounted to be attachable to/detachable from the stator assembly 120.

In addition, the rotor 110 of the motor according to the preferred embodiment of the present invention is provided with a salient pole 112 protruding toward the stator assembly 120, the stator assembly 120 is provided with a stator salient pole (not shown) facing the salient pole 112 of the rotor and having a coil wound therearound, such that the motor according to the preferred embodiment of the present invention may be implemented as a switched reluctance motor rotating the rotor using a reluctance torque according to a change in a magnetic reluctance.

In the motor 100 according to the preferred embodiment of the present invention as described above, in the case in which the shaft 111 rotates, electromotive force is generated by the permanent magnet 131 mounted on the shaft 111 and the induction coil part 132, and the generated electromotive force is measured, the measured electromotive force is compared with existing electromotive force calculated according to an air gap, thereby making it possible to calculate a distance D of an air gap between the rotor and the stator assembly.

In addition, a mechanical assembling state, an operation state, unbalance of a shaft, and the like, may be recognized through the distance of the air gap and the recognized information may be reflected in controlling the driving of the motor.

Hereinafter, a technical configuration of the air gap measuring module and measurement of a distance of the air gap and controlling according to the technical configuration of the air gap measuring module will be described in more detail.

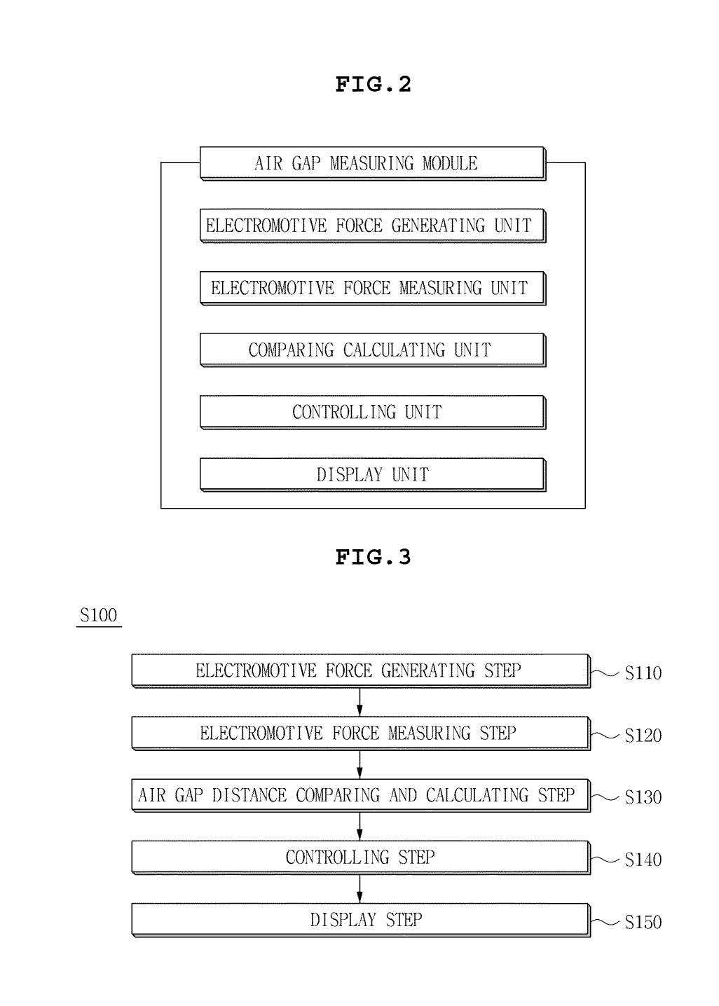

FIG. 2 is a configuration diagram schematically showing an air gap measuring module of the motor according to the preferred embodiment of the present invention. As shown in FIG. 2, the air gap measuring module includes an electromotive force generating unit, an electromotive force measuring unit, a comparing calculating unit, a controlling unit, and a display unit.

More specifically, the electromotive force generating unit, which is to generate electromotive force in the rotor and the stator assembly in the motor, may be implemented by the permanent magnet and the induction coil part mounted to face the permanent magnet, as shown in FIG. 1.

In addition, the electromotive force measuring unit, which is to measure the electromotive force generated in the electromotive force generating unit, measures analog electromotive force data generated in the electromotive force generating unit.

In addition, the comparing calculating unit converts the analog electromotive force data measured in the electromotive force measuring unit into digital electromotive force data and compares the digital electromotive force data with existing pre-stored electromotive force data according to an air gap to calculate the distance of the air gap. In this case, a minimum value and a maximum value of the digital electromotive force data may be analyzed for each time zone and the analyzed minimum value and maximum value may be used when the digital electromotive force data are compared with the existing data.

In addition, the controlling unit, which is to control the driving of the motor through the distance of the air gap calculated in the comparing calculating unit, transfers a signal to a speed controlling unit of the motor according to the distance of the air gap of the comparing calculating unit to control acceleration, deceleration, and stop of a driving speed.

Therefore, the distance of the air gap is measured during the driving of the motor to sense an abnormal state of the motor or judge the risk possibility, that is, bearing damage and shaft system abnormality, thereby making it possible to prevent accident.

In addition, the display unit displays an operation state of the motor including the distance of the air gap, a state of the air gap, and the driving speed of the motor by the controlling unit.

FIG. 3 is a flow chart schematically showing a method of measuring a distance of an air gap between a rotor and a stator assembly and controlling the driving of the motor according to the preferred embodiment of the present invention.

As shown in FIG. 3, the method (S100) of measuring a distance of an air gap between a rotor and a stator assembly of the motor and controlling the driving of the motor according to the preferred embodiment of the present invention includes an electromotive force generating step (S110), an electromotive force measuring step (S120), an air gap distance comparing and calculating step (S130), a controlling step (S140), and a display step (S150).

More specifically, in the electromotive force measuring step (S110), current is applied to the induction coil part mounted on the stator assembly so as to face the permanent magnet mounted on the rotor at the time of the driving of the motor, such that the electromagnetic force between the rotor and the stator assembly is generated.

Then, in the electromotive force measuring step (S120), the electromotive force generated in the electromotive force generating step is measured for each time zone.

Next, in the air gap distance comparing and calculating step (S130), the measured electromotive force data are compared with the pre-stored electromotive force data according to the air gap to calculate the distance of the air gap. That is, the data measured for each time zone are compared with existing data through data of an operation rpm, a time, a maximum value, and a minimum value to calculate the distance of the air gap.

Then, in the control step (S140), the driving of the motor is controlled through the distance of the air gap. That is, the signal is transferred to the speed controlling unit of the motor according to the distance of the air gap of the comparing calculating unit to control acceleration, deceleration, and stop of a driving speed.

Next, in the display step (S150), an operation state of the motor including the distance of the air gap, a state of the air gap, and the driving speed of the motor in the controlling step is displayed.

As set forth above, according to the preferred embodiments of the present invention, the motor capable of measuring the air gap between the rotor and the stator assembly by the electromotive force generated between the rotor and the stator assembly and capable of measuring the air gap between the rotor and the stator assembly during the driving of the motor to recognize a mechanical assembling state, an operation state, unbalance of a shaft, and the like, and reflecting the recognized information in controlling the driving of the motor may be obtained.

In addition, the method of measuring a distance of an air gap between a rotor and a stator assembly of the motor and controlling the driving of the motor capable of generating electromotive force in the induction winding between the rotor and the stator assembly according to the driving of the motor, measuring the generated electromotive force, and comparing the measured electromotive force with the existing electromotive force data according to an air gap to calculate the distance of the air gap, thereby controlling the driving of the motor, may be obtained.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A motor comprising:
a rotor including a shaft;
a stator assembly rotatably supporting the rotor; and
an air gap measuring module measuring a distance of an air gap between the shaft and the stator assembly by electromotive force generated between the rotor and the stator assembly.

2. The motor as set forth in claim 1, wherein the air gap measuring module includes:
an electromotive force generating unit generating electromotive force in the rotor and the stator assembly;
an electromotive force measuring unit measuring the electromotive force generated in the electromotive force generating unit;
a comparing calculating unit comparing electromotive force data measured in the electromotive force measuring unit with existing electromotive force data according to an air gap to calculate the distance of the air gap; and
a controlling unit controlling the driving of the motor through the distance of the air gap calculated in the comparing calculating unit.

3. The motor as set forth in claim 2, wherein the air gap measuring module further includes a display unit displaying an operation state of the motor including the distance of the air gap, a state of the air gap, and a driving speed of the motor by the controlling unit.

4. The motor as set forth in claim 2, wherein the electromotive force generating unit includes:
a permanent magnet on the shaft of the rotor; and
an induction coil part mounted on the stator assembly so as to face the permanent magnet and including a coil wound therearound.

5. The motor as set forth in claim 4, wherein a plurality of the permanent magnets are mounted on the shaft in a circumferential direction and a space part is formed between adjacent permanent magnets.

6. The motor as set forth in claim 2, wherein the electromotive force measuring unit measures analog electromotive force data generated in the electromotive force generating unit, and
the comparing calculating unit converts the measured analog electromotive force data into digital electromotive force data and compares the digital electromotive force data with pre-stored electromotive force data according to an air gap to calculate the distance of the air gap.

7. The motor as set forth in claim 2, wherein the controlling unit controls acceleration, deceleration, and stop of a motor driving speed according to the air gap calculated in the comparing calculating unit.

8. The motor as set forth in claim 2, wherein the rotor is provided with a salient pole protruding toward the stator assembly and the stator assembly is provided with a stator salient pole facing the salient pole of the rotor and having a coil wound therearound, such that the motor is implemented as a switched reluctance motor.

9. The motor as set forth in claim 8, wherein a permanent magnet is mounted to be attachable to/detachable from one end portion of the shaft of the rotor, and an induction coil part is mounted to be attachable to/detachable from the stator assembly facing the permanent magnet.

10. A method of measuring a distance of an air gap between the rotor and the stator assembly of the motor and controlling the driving of the motor as set forth claim 1, the method comprising:
an electromotive force generating step of generating electromotive force by an induction winding between the rotor and the stator assembly;
an electromotive force measuring step of measuring the generated electromotive force;
an air gap distance comparing and calculating step of comparing the measured electromotive force data with existing electromotive force data according to a distance of an air gap to calculate a distance of the air gap; and
a controlling step of controlling the driving of the motor according to the distance of the air gap.

11. The method as set forth in claim 10, wherein in the electromotive force generating step, current is applied to an induction coil part mounted on the stator assembly so as to face a permanent magnet mounted on the rotor according to the driving of the motor.

12. The method as set forth in claim 10, wherein in the electromotive force measuring step, the electromotive force generated in the electromotive force generating step is measured for each time zone.

13. The method as set forth in claim 10, wherein in the control step, a speed of the motor is controlled to be acceleration, deceleration, and stop according to the distance of the air gap.

14. The method as set forth in claim 10, further comprising a display step of displaying an operation state of the motor including the distance of the air gap, a state of the air gap, and a driving speed of the motor in the controlling step.
